(19) United States
(12) Patent Application Publication
(10) Pub. No.: US 2002/0097206 A1
(43) Pub. Date: Jul. 25, 2002

(54) LCOS automatic bias for common imager electrode

(76) Inventor: Donald Henry Willis, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 09/950,988

(22) Filed: Sep. 13, 2001

Related U.S. Application Data
(60) Provisional application No. 60/263,487, filed on Jan. 23, 2001.

(51) Int. Cl. G09G 3/36

(52) U.S. Cl. 345/87

(57) ABSTRACT

A circuit for automatically biasing a common electrode of a liquid crystal on silicon imager comprising an imager with a common electrode and a plurality of cells. A varying voltage signal is provided to the plurality of cells. A low pass filter is coupled between the varying voltage signal and a common junction coupled to the common electrode such that a bias voltage is formed at the common electrode having a value that approximates an average of the varying voltage signal.

### CROSS REFERENCE RELATED APPLICATION

This is a non-provisional application of provisional application serial No. 60/263,487, filed Jan. 23, 2001.

### FIELD OF THE INVENTION

The invention arrangements relate to the field of LCOS (liquid crystal on silicon) and/or LCD (liquid crystal display) for video projection systems.

### BACKGROUND OF THE INVENTION

LCOS can be thought of as one large liquid crystal formed on a silicon wafer. The silicon wafer is divided into an incremental array of tiny plates. A tiny incremental region of the liquid crystal is influenced by the electric field generated by each tiny plate and the common plate. Each such tiny plate and corresponding liquid crystal region are together referred to as a cell of the imager. Each cell corresponds is, to an individually controllable pixel. A common plate electrode is disposed on the other side of the liquid crystal.

The drive voltages are supplied from plate electrodes on each side of the LCOS array. In the presently preferred LCOS system to which the inventive arrangements pertain, the common plate is always at a potential of 8 volts. Each of the other plates in the array of tiny plates is operated in two voltage ranges. For positive pictures, the voltage varies between 0 volts and 8 volts. For negative pictures the voltage varies between 8 volts and 16 volts.

The light supplied to the imager, and therefore supplied to each cell of the imager, is field polarized. Each liquid crystal cell rotates the polarization of the input light responsive to the RMS value of the electric field applied to the cell by the plate electrodes. Generally speaking, the cells are not responsive to the polarity (positive or negative) of the applied electric field. Rather, the brightness of each pixel's cell is generally only a function of the rotation of the polarization of the light incident on the cell. As a practical matter, however, it has been found that the brightness can vary by about 5% between the positive and negative field polarities for the same polarization rotation of the light. Such variation of the brightness can cause an undesirable flicker in the displayed picture.

In the case of either positive or negative pictures, as the field driving the cells approaches a zero field, corresponding to 8 volts, the closer each cell comes to white, corresponding to a full on condition. Other systems are possible, for example where the common voltage is set to 0 volts. It will be appreciated that the inventive arrangements taught herein are applicable to all such positive and negative field LCOS imager driving systems. Pictures are defined as positive pictures when the voltage applied to the common plate electrode is greater than or equal to the largest possible value in the range of the variable plate voltages in the array of the other electrode. Conversely, pictures are defined as negative pictures when the voltage applied to the common plate electrode is less than or equal to the smallest possible value in the range of the variable plate voltages in the array of the other electrode. The designations of pictures as positive or negative should not be confused with terms used to distinguish field types in interlaced video formats.

It is typical to drive the imager of an LCOS display with a frame-doubled signal by sending first a normal frame (positive picture) and then an inverted frame (negative picture) in response to a given input picture. The generation of positive and negative pictures ensures that each pixel will be written with a positive electric field followed by a negative electric field. The resulting drive field has a zero DC component, which is necessary to avoid the image sticking, and ultimately, permanent degradation of the imager. It has been determined that the human eye responds to the average value of the brightness of the pixels produced by these positive and negative pictures.

The present state of the art in LCOS requires the adjustment of the common electrode voltage, denoted V_{ITO} or sometimes V_{COM}, to be precisely between the positive and negative field drive for the LCOS. The balance is necessary in order to minimize flicker, as well as to prevent a phenomenon known as image sticking.

In the prior art it is often tricky to properly bias the common electrode in an imager. Usually, it is done by guesswork. As noted above, when the bias voltage is not optimal there can be image sticking, flicker, and in extreme cases, damage to the imager. Typically, the dynamic range of the positive and negative pictures is chosen a and Vito is biased half way between them. This undesirably ignores the details of temperature and age.

### SUMMARY OF THE INVENTION

In accordance with a first aspect of the present invention and with reference to FIG. 1, a circuit 10 for automatically biasing the voltage to a common electrode in a liquid crystal on silicon imager 15 comprises an imager having a common electrode Ce and a plurality of cells 17 in the imager. The circuit 10 further comprises a voltage signal source 12 provided to the plurality of cells 17, a resistive load 16 providing resistance between voltage signal 12 and a common junction 17, and a capacitive load 18 providing capacitance between the common junction 17 and a point of reference potential. The common junction 17 is coupled to the common electrode Ce such that the voltage (Vᵢₜₒ) at the common electrode is a bias voltage having a value that approximates to an average value of voltage signal 12.

FIG. 2 illustrates the steps in the method of applying a bias voltage to a common electrode where the bias voltage is equal to the average of the overall voltages of each phase taken over one cycle of positive and negative images.

### BRIEF DESCRIPTION OF THE DRAWINGS

FIG. 1 is a circuit diagram showing the voltage averaging components of the invention.

FIG. 2 is a flow chart illustrating a method in accordance with the present invention.

### DETAILED DESCRIPTION OF THE INVENTION

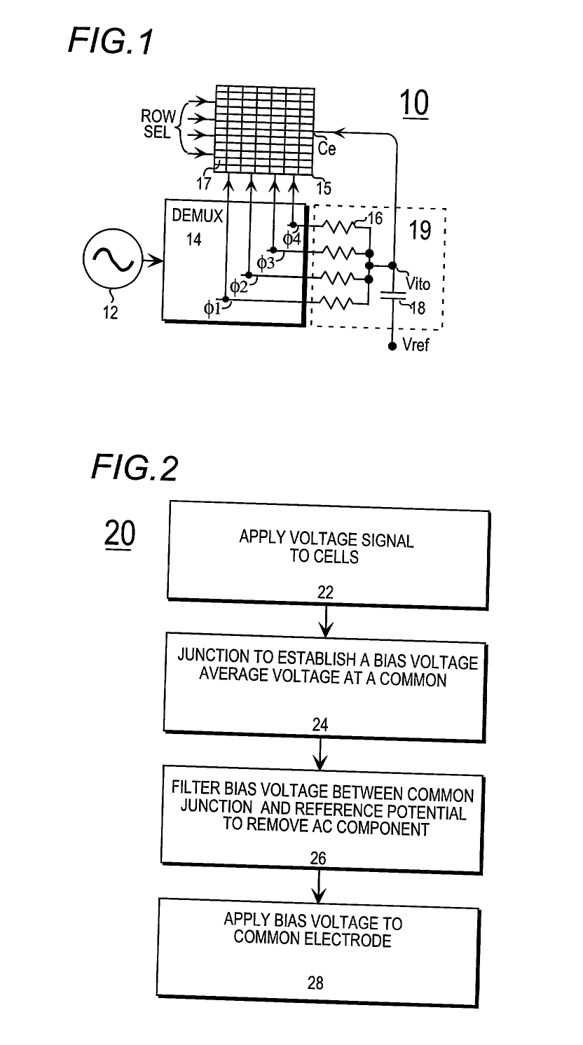

The improved automatic bias scheme in accordance with the inventive arrangements does not ignore the details noted above, and is shown in FIG. 1. In the preferred embodiment, a four-phase imager is driven with four analog voltage Signals Φ1-Φ4 to write all the pixels of both the positive frame and the negative frame. In the present state of the art, four phases are needed because a single 12, phase would require an excessively high analog sample rate and thus, too high a slew rate. Each phase carries every fourth pixel, so a demultiplexer 14 is preferably used in this instance to generate the four phases. The invention, however, is not limited to a phased voltage signal, as the future advancement of the art may obviate the requirement for a phased voltage signal and the use of the demultiplexer 14.

In FIG. 1, the improved bias circuit 10 averages all four signals Φ1-Φ4 by use of a low pass filter 19 formed by four equal value resistors 16, and a capacitor 18. The low pass filter network provides a long time constant with heavy low-pass filtering of the resulting combined voltage Vito. This voltage, Vito is suitable for biasing the common electrode of imager 15. Of course, buffers and feedback arrangements (not shown) can be used if the voltage developed has too high an impedance, but these embellishments are variations on the basic scheme of the inventive arrangements.

The values chosen for this circuit are relatively easy to select if the load impedance of the common plate or electrode Ce is very high. For example, each of the four resistors 16 can have a value of 1 megohm. The capacitor 18 is then selected to provide a time constant such as to substantially eliminate any expected AC voltage component from junction 17 and the common electrode. A value of 10 microfarads may be appropriate to achieve this function for a frame rate of 120 Hz. Voltages in the circuit are measured with respect to a point of reference potential, V_{ref} In some configurations, this reference potential may constitute a ground.

In accordance with a second aspect of the present invention and with reference to FIG. 2, a method 20 of applying voltage bias to a common electrode in a liquid crystal on silicon imager preferably comprises the step 22 of applying a varying voltage signal to a plurality of cells in an imager, and the step 24 of averaging the voltage of the voltage signal by placing a resistive load between the voltage signal and a common junction such that there is a bias voltage at the common junction. The method 20 further comprises the step 26 of filtering the bias voltage through a capacitive medium between the common junction and a point of reference potential to remove alternating current components, and the step 28 of applying the bias voltage to a common electrode.

The methods and apparatus illustrated herein teach how a common imager electrode may be biased to a voltage that is an overall average of the voltages of all cells in the imager. It will be understood that this invention is not limited to the specific embodiments shown and disclosed herein, and that other modifications may be made to the embodiments within the principles of the invention as recited in the appended claims. For example, with regard to the multiple phase voltage, there may be any number of phases from one to ten or more. The same is true with regard to the resistance—capacitance circuit or the resistive and capacitive loads, which may involve other components values or time constants as necessary to achieve the desired bias voltage filtering without a substantial AC component.

Although the present invention has been described in conjunction with the embodiments disclosed herein, it should be understood that the foregoing description is intended to illustrate and not limit the scope of the invention as defined by the claims.

What is claimed is:

1. A circuit for automatically biasing a common electrode in a liquid crystal on silicon imager comprising:
an imager having a common electrode;
a plurality of cells in said imager;
a varying voltage signal provided to said plurality of cells; and,
a low pass filter coupled between said varying voltage signal and a common junction, said common junction being coupled to said common electrode such that a bias voltage is formed at said common electrode having a value that approximates an average of said varying voltage signal.

2. The circuit as claimed in claim 1, wherein said low pass filter includes a plurality of resistors joined at said common junction and decoupled by a capacitor coupled to a reference potential.

3. The circuit as claimed in claim 2, wherein each resistor of said plurality of resistors has an approximately equal resistance value.

4. The circuit as claimed in claim 1, wherein said varying voltage signal has values in a range from approximately zero volts to approximately 16 volts, and said bias voltage has a value of approximately 8 volts.

5. The circuit as claimed in claim 4, wherein said varying voltage signal further comprises cell voltages varying from approximately zero volts to approximately eight volts to create positive images, and cell voltages varying from approximately eight volts to approximately 16 volts to create negative images, said positive images and said negative images being alternately applied to said cells, and said bias voltage approximates the overall average value of voltages used to create said positive and said negative images.

6. The circuit as claimed in claim 2, further comprising a demultiplexer receiving said varying voltage signal and providing a plurality of separate voltage signal outputs, each said separate voltage signal output corresponding to one phase of a multiple phase signal.

7. The circuit as claimed in claim 6, wherein said plurality of resistors provide electrical paths between each of said plurality of voltage signal outputs and said common junction.

8. The circuit as claimed in claim 6, wherein said multiple phase signal comprises four phases.

9. The circuit as claimed in claim 1, wherein an AC component of said bias voltage is substantially zero.

10. The circuit as claimed in claim 3, wherein said plurality of resistors each have a resistance value of approximately 1 megohm and said capacitor has a capacitance value of approximately 10 microfarads.

11. A method of applying a voltage bias to a common electrode in a liquid crystal on silicon imager, comprising the steps of:
applying a voltage signal to a plurality of cells in an imager;
averaging at a common junction said voltage signal at to create a bias voltage;
substantially removing an alternating current component of said bias voltage at said common junction; and
applying said bias voltage to a common electrode of said imager.

12. The method of claim 11, further comprising the steps of;
creating positive images when said voltage signal is less than or equal to said bias voltage;
forming negative images when said voltage signal is greater than or equal to said bias voltage, and,
filtering said voltage signal to form said bias voltage having an average value of said voltages in said voltage signal used to create said positive images and said negative images.

13. The method of claim 12, comprising the further steps of;
applying said voltage signal to create said positive images and said negative images in an alternating sequence.

14. The method of claim 13, wherein said applying step further comprises the step of applying a varying voltage signal.

15. The method of claim 11, wherein said voltage signal of said applying step comprises a multiple phase voltage signal.

16. The method of claim 15, wherein said averaging step further comprises the step of;
resistively coupling each phase of said multiple phase voltage signal to said common junction via resistors of equal value.

17. The method of claim 12, wherein said filtering step further comprises the step of coupling said bias voltage with a capacitive medium extending between said bias voltage and a point of reference potential.

18. The method of claim 15, wherein said multiple phase voltage signal comprises four phases.

19. The method of claim 12, wherein said creating step said positive images are created with voltages that vary from approximately zero volts to approximately eight volts and said negative images are created with voltages that vary from approximately eight volts to approximately sixteen volts, and said bias voltage is approximately eight volts.

20. The method of claim 17, wherein said capacitance medium forms a low pass filter such that any AC component of said bias voltage at said common junction is reduced to substantially zero.
